(19) United States
(12) Patent Application Publication
(10) Pub. No.: US 2006/0123962 A1
(43) Pub. Date: Jun. 15, 2006

(54) Portable saw guide

(76) Inventor: Norston Fontaine, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/287,535

(22) Filed: Nov. 23, 2005

Related U.S. Application Data
(60) Provisional application No. 60/630,337, filed on Nov. 23, 2004.

(51) Int. Cl. B26D 7/06

(52) U.S. Cl. 83/446

(57) ABSTRACT

A saw guide for use with portable power tools is disclosed. A portable saw guide in accordance with an illustrative embodiment of the present invention may include a generally flat body having a first side, a second side, a first end, and a second end, and a support surface disposed on a top side of the body and configured to movably support a cutting tool thereon. The saw guide can be configured to precisely align the blade of the cutting tool orthogonal to the cutting edge of a workpiece without the need to mark a line prior to cutting.

This application claims priority to U.S. Provisional Application Ser. No. 60/630,337 filed Nov. 23, 2004.

### FIELD

The present invention relates generally to the field of power tools and accessories. More specifically, the present invention pertains to guiding devices for use with portable power tools.

### BACKGROUND

Saw guides are often utilized in conjunction with portable power tools to facilitate cutting of workpieces along a particular line and/or at a desired angle. Typically, such devices include a guide track that serves to guide the poser tool along a desired path above the workpiece surface. To make an accurate cut with the saw guide, the user must usually measure and draw a mark on the workpiece surface to be cut, and then set the saw guide to the desired cut width before use. In more advanced designs, a sliding or adjustable guide track may be provided to permit the user to adjust the cut width without marking. Such designs, however, often obligate the user to manually set the saw guide with an adjustment knob, clamp, screw or other such mechanism, increasing the number of steps necessary to setup the device.

The ability to rapidly and precisely cut irregular shaped workpieces can pose a significant hurdle for many saw guides. During cutting, movement of the cutting tool along the guide track can cause kickback of the workpiece, reducing the ability of the cutting tool to provide a precise cut through the workpiece. In some cases, the shape of the workpiece may prevent cutting altogether, obligating the user to use more complicated and/or less portable methods.

### SUMMARY

The present invention relates generally to guiding devices for use with portable power tools. A saw guide in accordance with an illustrative embodiment of the present invention may include a generally flat body having a first side, a second side, a first end, and a second end; and a support surface disposed on a top side of the body and configured to movably support a cutting tool thereon. The support surface can be utilized to precisely align the blade of the cutting tool with the first side of the body, allowing the user to precisely cut the workpiece without having to first place a mark the workpiece surface using a separate instrument such as a straight edge. A guardrail comprising an upwardly extending portion of the body can be provided to track the cutting tool along a line perpendicular to the cutting edge of the workpiece. In some embodiments, a number of elongated channels oriented lengthwise along the width of the saw guide can be provided to reduce friction between the cutting tool and the support surface. Other features relating to the saw guide are further described herein.

### BRIEF DESCRIPTION OF THE DRAWINGS

FIG. 1 is a top perspective view showing an illustrative saw guide in accordance with an exemplary embodiment of the present invention;

FIG. 2 is a side elevation view showing the first end of the illustrative saw guide of FIG. 1 in greater detail;

FIG. 3 is a bottom perspective view of the illustrative saw guide of FIG. 1;

FIG. 4 is a top view showing the top side of the illustrative saw guide of FIG. 1 in greater detail; and

FIG. 5 is top perspective view showing the illustrative saw guide of FIG. 1 attached to a workpiece.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

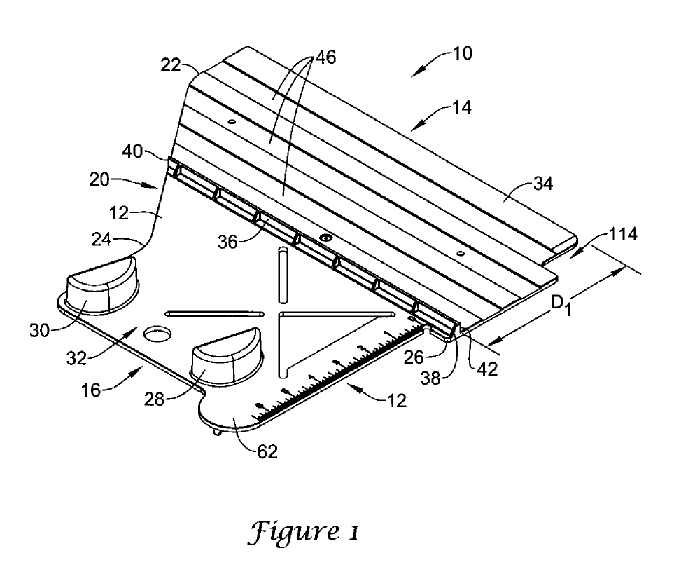

FIG. 1 is a top perspective view showing an illustrative saw guide 10 in accordance with an exemplary embodiment of the present invention. Saw guide 10 may include a generally flat body 12 having a first side 14, a second side 16, a first end 18, and a second end 20. The first and second sides 14,16 of the body 12 may run substantially parallel to each other, and may define a general width of the saw guide 10 that extends from the first end 18 of the body 12 to the second end 20 thereof. The first and second ends 18,20 of the body 12, in turn, may vary in distance with respect to each other, and may define a general length of the body 12 that extends orthogonally from the first side 14 of the body 12 to the second side 16 thereof.

The body 12 may have a flared shaped formed by a decrease in the overall width of the saw guide 10 towards the second side 16 of the body 12. In the illustrative embodiment of FIG. 1, for example, the second end 20 of the body 12 may slope inwardly towards the interior of the body 12 from location 22 to 24, gradually reducing the width of the saw guide 10 such that second side 16 of the body 12 is generally shorter than the first side 14. The first end 18 of the body 12, in turn, may have a generally straight configuration, having a slight reduction in width at location 26. In use, the flared shape of the saw guide 10 facilitates visualization of the underlying workpiece, and allows the user to grasp the opposing edge of the workpiece with a forefinger and/or middle finger while also gripping the body 12.

The saw guide 10 may be formed from any number of suitable materials and/or fabrication techniques. Examples of suitable materials may include polymers such as acrylonitrile butadiene styrene (ABS), polypropylene (PP), polyvinylchloride (PVC), nylon, etc., metals such as aluminum or steel, or composites thereof. In certain embodiments, for example, the saw guide 10 may be fabricated from a glass filled nylon or polycarbonate material using an injection molding process. In some embodiments, the material used to form the body 12 may comprise a transparent material such as clear acrylic to further aid in visualizing the underlying workpiece. To ensure accurate cutting of the workpiece after repeated use, the saw guide 10 will typically be formed from a relatively hard material having a low coefficient of thermal expansion that resists warping, shrinkage or irregularities that can reduce the precision of the device.

As can be further seen in FIG. 1, the saw guide 10 may further include a number of handle grips 28,30 that can be utilized to hold the body 12 in place against the workpiece. In the illustrative embodiment of FIG. 1, for example, a first handle 28 positioned relatively close to the first end 18 of the body 12 can be provided as a grip to hold the saw guide 10 flush against the surface of the workpiece. A second handle 30 positioned on the body 12 can be similarly provided as a grip to hold the saw guide 10 flush against the surface of the workpiece, but at distance further away from the first end 18 than the first handle 28 to facilitate holding the body 12 against relatively wide and/or oversized workpieces. Each of the handles 28,30 can be fabricated from a relatively soft material (e.g. rubber) to facilitate gripping, and can be positioned above the top side 32 of the body 12 so as to reduce the rotation of the saw guide 10 when engaged by the user against the workpiece. In certain embodiments, the second handle 30 may be positioned at or near the second end 20 of the body 12, allowing the user to grip the opposing edge of the workpiece with one or more fingers while also gripping the handle 30 with the palm and thumb.

A support surface 34 of the body 12 can be configured to movably support a portable power saw or other such cutting tool over the top side 32 of the saw guide 10. In the illustrative embodiment of FIG. 1, the support surface 34 is shown extending lengthwise along the width of body 12, and may have a depth D₁ demarcated by a guardrail 36 that runs substantially parallel to the first side 14. The support surface 34 can be dimensioned to provide a level cutting surface for the precise cutting of any number of workpiece types and/or shapes. In certain embodiments, for example, the support surface 34 can be utilized to cut irregular-shaped workpieces such as I-beams or C-channels. The support surface 34 can be configured to movably support any number of cutting tools including, but not limited to, circular saws, reciprocating saws, jigsaws, band saws, and/or routers.

The guardrail 36 may comprise an upwardly extending portion of the body 12 having a first end 38, a second end 40, and a flat face 42 oriented in an outward direction towards the first side 14 of the body 12. The guardrail 36 may be formed integrally with the body 12 (e.g. during injection molding), or, alternatively, can be formed as a separate piece that is later attached to the body 12. In the illustrative embodiment of FIG. 1, the guardrail 36 is fixed in position along the top side 32 of the body 12, preventing the user from adjusting the angle at which cutting occurs. In other embodiments, however, the guardrail 36 may be adjustably positioned on the body 12, allowing the user to adjust the cutting angle, if desired. In use, the guardrail 36 facilitates tracking of the cutting tool as it is moved across the support surface 34, maintaining a precise cutting angle as the cutting tool is advanced against the cutting edge of the workpiece.

In certain embodiments, a small, rectangular-shaped notch 44 can be provided at the corner of the saw guide 10. During the initial use of the saw guide 10, the notch 44 permits the user to make a first pass of the cutting tool parallel to the first side 14 of the support surface 34, cutting off any portion of support surface 34 located beyond (i.e. to the right of) the cutting blade. Once the depth D₁ of the support surface 34 is calibrated to the particular cutting tool to be used, the first side 14 can thereafter be utilized as a straight edge for the cutting blade, allowing the user to cut the workpiece without having to first mark a cutting line. In certain applications, the ability to precisely cut the workpiece in this manner obviates the need to place separate markings on the surface of the workpiece, reducing the time and/or number of steps required to cut the workpiece.

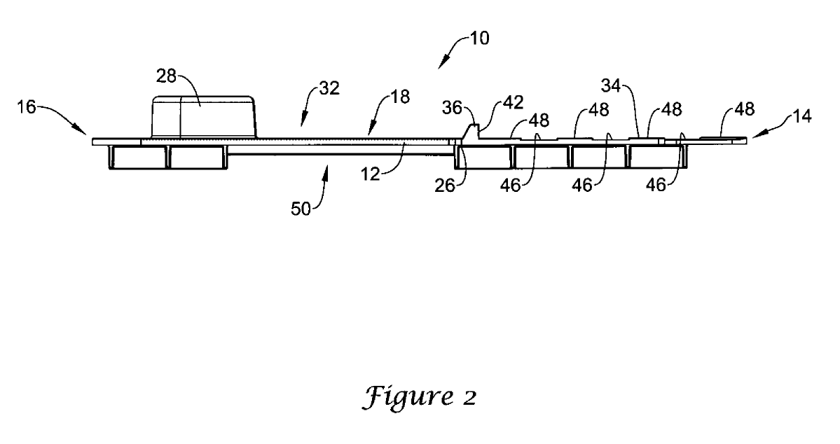

The support surface 34 may further include a number of elongated channels 46 that can be configured to reduce friction between the cutting tool and the support surface 34 that can cause kickback as the cutting tool is advanced against the workpiece. In the illustrative embodiment of FIG. 1, each of the elongated channels 46 may extend along the entire width of the saw guide 10 from the first end 18 of the body 12 to the second end 20 thereof. As can be further seen in the side elevation view of FIG. 2, each elongated channel 46 can be recessed a short distance into the support surface 34, forming a number of engagement surfaces 48 thereon that contact the bottom of the cutting tool as it is advanced across the support surface 34. In use, such configuration reduces the contact surface area between the cutting tool and the support surface 34, which helps the cutting tool to glide smoothly across the support surface 34. In certain embodiments, a similar set of elongated channels (not shown) recessed within the bottom side 50 of the saw guide 10 and staggered in position with the elongated channels 46 recessed within the top side 32 can be provided to facilitate injection molding of the body 12, and to prevent bowing of the support surface 34 when subjected to the weight of the cutting tool from above.

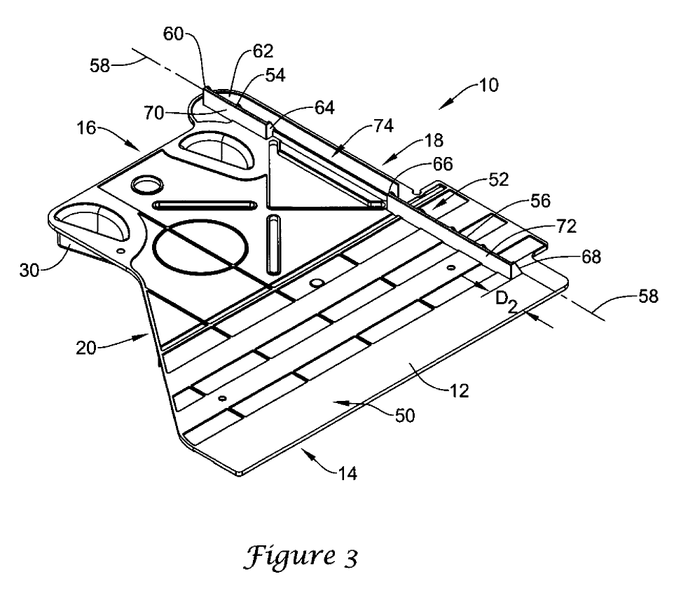

FIG. 3 is a bottom perspective view of the illustrative saw guide 10 of FIG. 1, showing the bottom side 50 of the saw guide 10 in greater detail. As can be seen in FIG. 3, the bottom side 50 of the body 12 may have a generally flat configuration, allowing the saw guide 10 to sit flush against the top side of the workpiece. An edge rail 52 extending lengthwise along the bottom side 50 of the body 12 can be provided to permit the user to abut the saw guide 10 firmly against the cutting edge of the workpiece.

The edge rail 52 may comprise two separate rail members 54,56, each extending lengthwise along an imaginary axis 58 oriented substantially orthogonal to the guardrail 36 located on the top side 32 of the saw guide 10. The first rail member 54 may extend from a first end 60 located adjacent to an extended portion 62 of the body 12 to a second end 64 thereof. The second rail member 56, in turn, may extend from a first end 66 located adjacent to location 26 of the body 12 to a second end 68 thereof, and can be inset a depth D₂ from the first side 14 of the body 12 to permit a portion of the support surface 32 to be removed, as described hereinabove. Each of the rail members 54,56 may have a respective, inwardly directed face 70,72, which together can be configured to abut the cutting edge of the workpiece at two separate locations spaced apart by an open portion 74. In use, the two rail members 54,56 permit the saw guide 10 to abut the cutting edge of the workpiece at two separate, spaced-apart locations to reduce rocking which can occur with the use of a single, relatively long rail member.

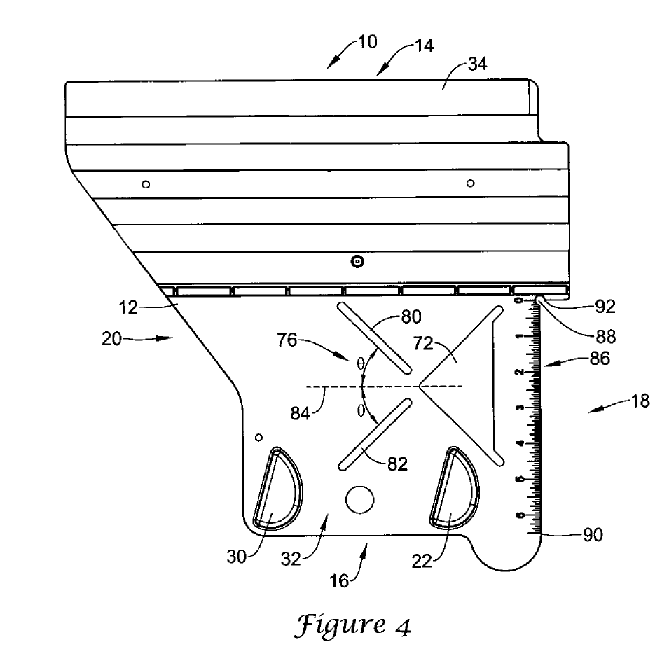

FIG. 4 is a top view showing the top side 32 of the illustrative saw guide 10 of FIG. 1 in greater detail. As shown in FIG. 4, the top side 32 of the saw guide 10 may include a number of features thereon to permit the user to make various markings on the surface of the workpiece, if desired. A dimensioning section 76 of the saw guide 10 occupying the portion of the top side 32 not including the support surface 34 may include a viewing opening 78 and a number of narrow slits 80,82, which, in use, can be used to place various markings on the workpiece surface. The viewing opening 78 may have a substantially triangular shape that exposes a portion of the underlying workpiece to enhance visualization. The narrow slits 80,82, in turn, can be dimensioned to receive a pen or pencil tip to permit the user to place angle markings on the workpiece surface to facilitate cutting at various angles. In certain embodiments, for example, the narrow slits 80,82 can each be oriented at an angle θ of about 45° relatively to an imaginary line 84 that runs along the width of the saw guide 10. While the narrow slits 80,82 in the illustrative embodiment of FIG. I are shown oriented orthogonally to each other, it should be understood that the narrow slits 80,82 could be oriented at other various angles, as. Moreover, while two narrow slits 80,82 are specifically illustrated, it should be understood that a greater or lesser number of slits could be provided through the saw guide 10, as desired.

As can be further seen in FIG. 4, the dimensioning section 76 may also include a ruler 86 to permit the user to make various measurements on the workpiece without having to use a separate instrument such as a straight edge. In the illustrative embodiment depicted in FIG. 4, the ruler 86 may include a number of scale markings extending along a portion of the first end 18, beginning at a first location 88 labeled as “0” in FIG. 1 to a second location 90 thereof. The scale markings may be expressed in English units (e.g. “inches”, “feet”, etc.), SI units (e.g. “centimeters”, “millimeters”, etc.), or both, and can include optional sub-markings, as shown. A semi-circular notch 92 inset within the first end 18 of the body 12 allows the user to make a precise mark on the surface of the workpiece immediately adjacent to the “0” mark on the scale.

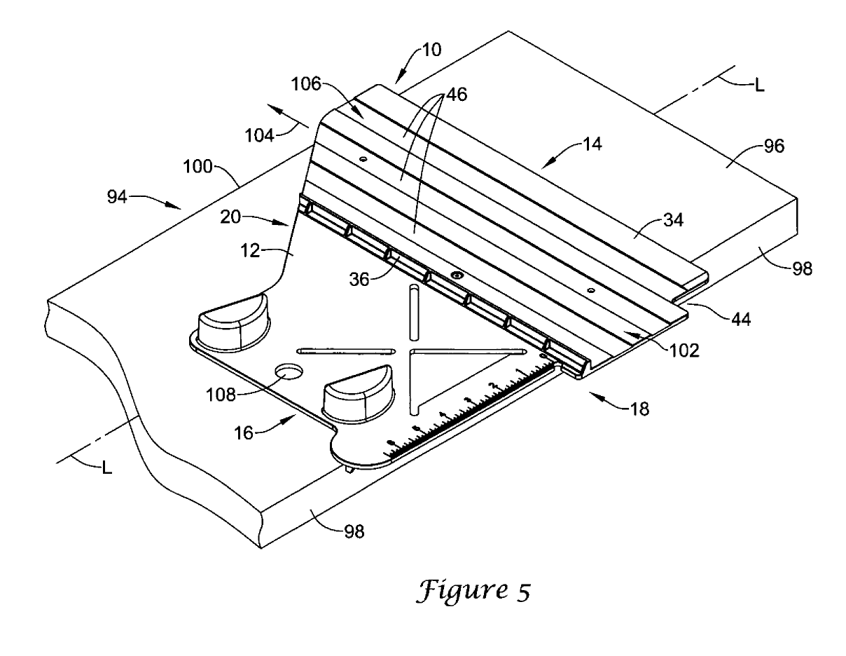

FIG. 5 is a top perspective view showing the illustrative saw guide 10 of FIG. 1 attached to a workpiece 94. As shown in FIG. 5, the workpiece 94 may have a top surface 96, a bottom surface (not shown), a cutting edge 98, and an opposing edge 100. In preparation for cutting, and prior to the first use, the cutting tool can be aligned with the guardrail 36 of the saw guide 10 and advanced across the width of the support surface 34 to trim any excess material from the body 12, thereby setting the proper depth of the saw guide 10 to the particular cutting tool being used.

Once initially set, the saw guide 10 can then be positioned on the top surface 96 of the workpiece 94 and aligned such that the faces 70,72 of each rail member 54,56 lie adjacent to and abut the cutting edge 98 of the workpiece 94. When placed against the workpiece 94 in this manner, the saw guide 10 acts as a “T”, allowing a cutting tool (not shown) placed on the support surface 34 flush against the guardrail 36 to align orthogonally with the longitudinal axis L of the workpiece 94.

To cut the workpiece 94, the leading end of the cutting tool can be positioned on an overhanging section 102 of the support surface 34 that extends beyond the cutting edge 98 of the workpiece 94, and then advanced in a direction indicated generally by arrow 104, causing the cutting tool to precisely cut a line parallel to the width W of the workpiece 94. As the cutting tool moves in the direction indicated by arrow 104, the elongated channels 46 recessed within support surface 34 act to reduce the contact surface area between the base of the cutting tool and the support surface 34, thereby reducing kickback. A second overhanging section 106 of the support surface 34 extending beyond the opposing edge 100 of the workpiece 94 can be configured to support the cutting tool as the blade is engaged past the opposing edge 100, thus ensuring that the cutting blade passes through the entire width W of the workpiece 94 without causing splintering. After use, a small hole 108 provided near the second side 16 of the body 12 can be used hang the saw guide 10 on a hook or peg for storage, if desired.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A portable saw guide, comprising:
a generally flat body having a first side, a second side, a first end, and a second end; and
a support surface disposed on a top side of the body, said support surface being configured to movably support a cutting tool thereon.

2. The portable saw guide of claim 1, wherein the body has a flared shape that decreases in overall width from the first side of the body to the second side thereof.

3. The portable saw guide of claim 1, wherein the body comprises a polymeric material.

4. The portable saw guide of claim 1, wherein the body comprises a transparent material.

5. The portable saw guide of claim 1, wherein the support surface includes a guardrail.

6. The portable saw guide of claim 1, wherein the support surface includes a notch.

7. The portable saw guide of claim 1, wherein the support surface includes a number of elongated channels.

8. The portable saw guide of claim 7, wherein each elongated channel extends along the entire width of the support surface from the first end of the body to the second end thereof.

9. The portable saw guide of claim 1, further including at least one handle grip.

10. The portable saw guide of claim 9, wherein said at least one handle grip comprises a first handle grip and a second handle grip.

11. The portable saw guide of claim 5, further including an edge rail disposed on a bottom side of the saw guide.

12. The portable saw guide of claim 11, wherein the edge rail is oriented orthogonally relative to the guardrail.

13. The portable saw guide of claim 11, wherein the edge rail includes a first rail member and a second rail member.

14. The portable saw guide of claim 1, wherein the body further includes a dimensioning section.

15. The portable saw guide of claim 14, wherein the dimensioning section includes a viewing opening.

16. The portable saw guide of claim 14, wherein the dimensioning section includes a number of narrow slits.

17. The portable saw guide of claim 14, wherein the dimensioning section includes a ruler.

18. The portable saw guide of claim 17, further including a semi-circular notch formed in the first end of the body adjacent said ruler.

19. The portable saw guide of claim 1, wherein said cutting tool comprises a saw.

20. The portable saw guide of claim 1, wherein said cutting tool is selected from the group of portable cutting tools consisting of a circular saw, a reciprocating saw, a jigsaw, a band saw, and a router.
